(19) United States
(12) Patent Application Publication
(10) Pub. No.: US 2005/0240726 A1
(43) Pub. Date: Oct. 27, 2005

(54) Synergistic hybrid disk drive

(75) Inventor: Larry Lynn Williams, Los Altos, CA (US)

Correspondence Address: John L. Rogitz;Rogitz & Associates, Suite 3120, 750 B Street, San Diego, CA, 92101, US

(73) Assignee: Hitachi Global Storage Technologies Netherlands B.V., Amsterdam (NL)

(21) Appl. No.: 10/832,514

(22) Filed: Apr. 27, 2004

(51) Int. Cl. G06F 12/16

(52) U.S. Cl. 711/114; 710/22; 711/162

(57) ABSTRACT

Two or more disk drives communicate directly with each other to establish a synergistic hybrid disk drive (SHDD) that supplies data to a computer system faster and more reliably than would be expected from either individual disk drive. The two disk drives may have significantly different performance characteristics.

### I. FIELD OF THE INVENTION

The present invention relates generally to computer systems that employ disk drives.

### II. BACKGROUND OF THE INVENTION

The use of computer hard disk drives, both magnetic and optical, is well known in a wide number of computer fields, including personal computing. In computers, data is stored and retrieved from one or more disk drives by commands transmitted to the storage subsystem over a system bus. In a read command, for example, a command is transmitted to all disk drives that might happen to be connected to the bus, and each disk drive interprets the command and determines whether the command is addressed to this particular disk drive. If so, the disk drive supplies the data back to the system over the bus. The disk drives typically do not communicate with each other, however, so performance of one drive is not enhanced by the presence of another disk drive that might happen to be connected to the bus.

Contention limits the performance of high performance disk drives. That is, the disk drive may be instructed to retrieve a multiplicity of data blocks which are usually scattered over the disk surface. To retrieve the data, the disk drive must first position the read head over the appropriate track and wait for the desired block to pass under the head. One of the major components of the delay is latency, i.e., the time required for the disk to revolve once in those cases where the head has just arrived over the desired track slightly too late. Because of this fundamental problem, new disk drives are designed to spin the disks faster, but faster spin can result in reliability problems. As recognized by the present invention, the characteristics of two disk drives, one a high performance disk drive and one a significantly lower performance disk drive, may be combined, such that the overall performance of the storage system is significantly increased.

### SUMMARY OF THE INVENTION

Embodiments of the present invention provide for a combination of a high performance disk drive and a physically smaller and lower cost drive. The combination of these disk drives, referred to herein as a “synergistic hybrid disk drive” (“SHDD”), results in significantly improved overall performance without sacrificing reliability.

In the present computer storage system, a hybrid is a combination of two or more storage subsystems that have different characteristics. The differences may include differences in performance, power consumption, physical size, cost, weight, or more subtle differences in failure rate or long term reliability. In this invention, disk drives with different characteristics are combined such that such that the combination of two or more disk drives with different characteristics provide a superior solution to a particular application, e.g. a synergistic hybrid disk drive. For example, in a “high performance” application where access rate is very important, a disk drive with very high access rate may be combined with another disk drive with more moderate access rate such that the access rate of the combination (or hybrid) is nearly twice the access rate of the high performance disk drive without significantly sacrificing power consumption, physical size, cost, weight, or reliability. In a second example, an application may require high performance for some data, but very high reliability for other critical data. In this application, the data is dispersed on two or more disk drives such that critical data will be available even if one of the disk drives fails. In addition, using the hybrid nature of the disk drives proposed in this invention, reliability of the combination can be much better than either disk drive without significantly increasing other characteristics such as power consumption, size, or weight. In general, this invention combines two or more disk drives with different characteristics into a hybrid combination such that the characteristics of the combination is superior to either of the disk drives.

It is to be understood that the present invention relates to a multiplicity of storage media (disk drives, floppy drives, optical drives, tape drives, electronic storage, and the like), but for simplicity, the description below will discuss disk drives.

Accordingly, a computer system can include a primary disk drive having a controller connectable to a system bus and a secondary disk drive also having a controller connectable to the system bus. The drive controllers can communicate directly with each other without requiring communication with any other processing apparatus.

The primary disk drive may be a high performance disk drive. If desired, the secondary drive may be mounted on an electronic card packaged with the high performance drive.

In some embodiments, seldom-changed data can be stored on the secondary disk drive, with the secondary disk drive satisfying requests from a host computer for the seldom-changed data. In some embodiments, critical data may be stored on both the secondary disk drive and primary disk drive. The primary disk drive can satisfy requests for the critical data under conditions of low contention on the primary disk drive, with the secondary disk drive satisfying requests for the critical data otherwise.

Also, in some embodiments the secondary disk drive can store at least portions of an operating system that are required by a host computer during power-up. The portions of the operating system can be supplied to the host computer from the secondary disk drive during power-up.

In another aspect, a storage system includes a primary storage device having a primary controller and a secondary storage device having a respective controller communicating directly with the primary controller for satisfying data requests from a host computer. The host computer communicates with both storage devices over a bus. One or both controllers execute logic for undertaking at least activity from the group of activities consisting of (1) causing the secondary storage device to satisfy requests from a host computer for seldom-changed data, (2) causing the primary storage device to satisfy requests for critical data under conditions of low contention on the primary storage device and otherwise causing the secondary storage device to satisfy requests for critical data, and (3) causing at least portions of an operating system to be supplied from the secondary storage device to a host computer during power-up.

In still another aspect, a method for satisfying requests for data from a host computer includes establishing direct communication between a primary disk drive and a secondary disk drive without requiring the intercession of another processor. The method also includes, depending on the content of a request for data, causing at least one disk drive controller to determine which disk drive will satisfy the request.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is block diagram of the present system architecture, showing only two disk drives for clarity;

FIG. 2 is an exploded view of one non-limiting implementation of the present system, showing a secondary disk drive mounted on an electronic card that in turn can be mounted on a primary disk drive embodied as a high performance disk drive, showing the positions of the disk packs as installed in phantom; and

FIG. 3 is a flow chart of logic that can be implemented by the system shown in FIGS. 1 and 2.

### DETAILED DESCRIPTION OF THE PREFERRED EMBODIMENT

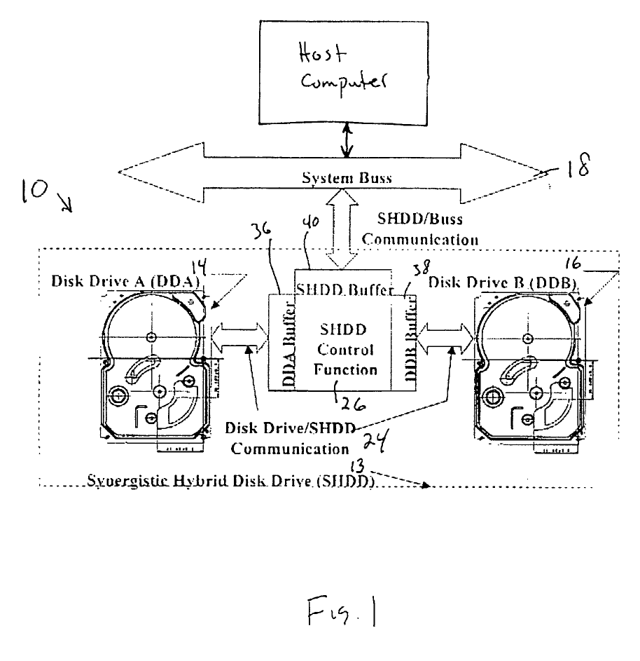

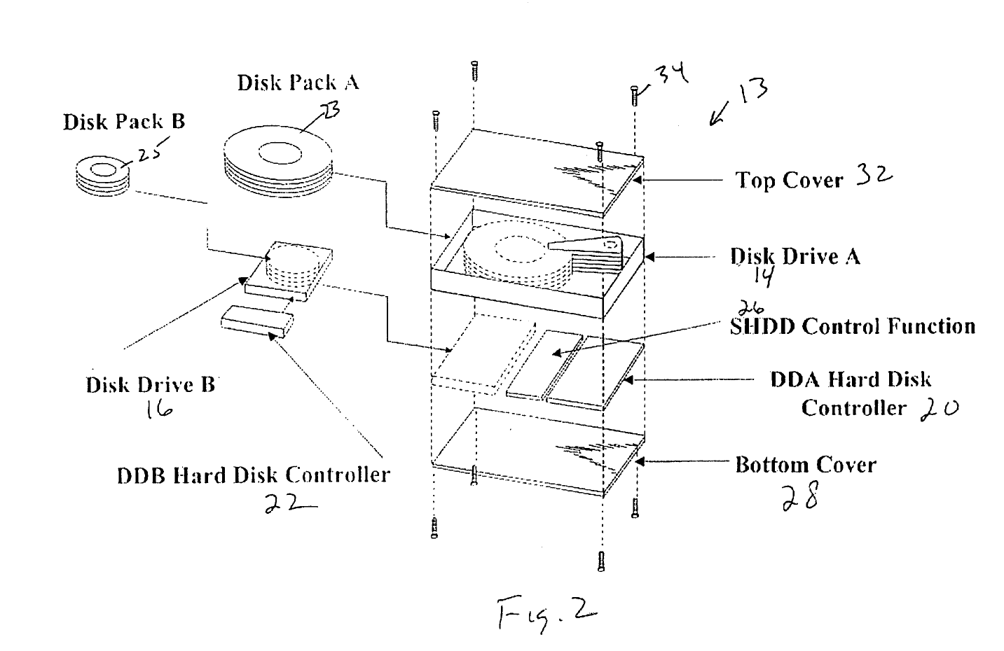

Referring initially to FIGS. 1 and 2, a system is shown, generally designated 10, that includes a host computer 12 that can communicate with a synergistic hybrid disk drive (SHDD) 13 which includes two or more disk drives (a primary disk drive 14, labelled “disk drive A” in the figures and a secondary disk drive 16, labelled “disk drive B”, are shown) over a system bus 18. Each disk drive 14, 16 of the SHDD 13 has a respective disk drive controller 20, 22 (FIG. 2) and respective disk packs 23, 25 (FIG. 2). In accordance with present principles, the disk drive controllers 20, 22 may communicate with the host computer 12 over the bus 18, and can also communicate directly with each other through the bus 18 or, as shown in FIG. 1, through a dedicated drive-drive bus 24. By “direct” is meant that the disk drives 14, 16 can communicate with each other without the need for another processor, such as the host computer 12, to intervene/control the drive-to-drive communication.

In a preferred embodiment, the primary disk drive 14 may be a high performance disk drive such as a server class disk drive that spins at, e.g., ten thousand or fifteen thousand revolutions per minute and that can hold, e.g., four hundred Gigabytes or more of data. Examples of such disk drives include those marketed under the trademarks Ultrastar and Deskstar. A preferred non-limiting secondary disk drive 16 can be implemented by a small disk drive (i.e., a disk drive with disks of diameters of two and half inches or smaller) that spins at, e.g., fifty hundred RPM. In such an embodiment, the primary disk drive 14 requires most of the resources (power, cooling, etc.), and the secondary disk drive 16 requires significantly less. Or, one disk drive can be a slow performing but high capacity disk drive and the other can be a fast performing but low capacity disk drive.

In a particularly preferred embodiment shown in FIG. 2, the secondary disk drive 16 could packaged on or with an electronics card 26 (labelled “SHDD control function”) that is associated with the controller 20 of the primary disk drive 14, such that the overall package is virtually identical to the primary disk drive alone. The card 26 can contain logic for executing the steps below, or either controller 20, 22 can contain the logic, or the logic can be distributed through the SHDD 13. In any case, the card 26 can be sandwiched between the primary disk rive 14 and a bottom cover 28, with the primary disk drive 14 being covered by a top cover 30. Threaded fasteners 32 can be used to hold the assembly shown in FIG. 2 together.

Referring back to FIG. 1, the card 26, in addition to containing, if desired, the logic below as indicated by the words “SHDD control function”, can also include one or more data buffers. Specifically, the card 26 can contain a primary disk drive data buffer 36, a secondary disk drive data buffer 40, and a SHDD data buffer 40 interfacing with the system bus 18 as shown. The data buffers 36, 38 can be implemented by the disk drive controllers 20, 22 if desired. The data buffers can be implemented by solid state memory devices to facilitate communication between the components shown, in accordance with further disclosure below.

Regardless of where in the SHDD 13 it is implemented, the SHDD control function can include, among other things, statistics to support certain of the logic below. For instance, the SHDD 13 control function can maintain a table or other data structure showing, for each data file stored in the SHDD 13, which disk drive it is located on and the number of times the data file is retrieved by the host computer 12 without be rewritten (used for defining “seldom changed” data), as well as the number of times the data file has been rewritten. Also, the SHDD control function can maintain a record of when the last read was for each data file, and how many times the data record was read in some window around that time.

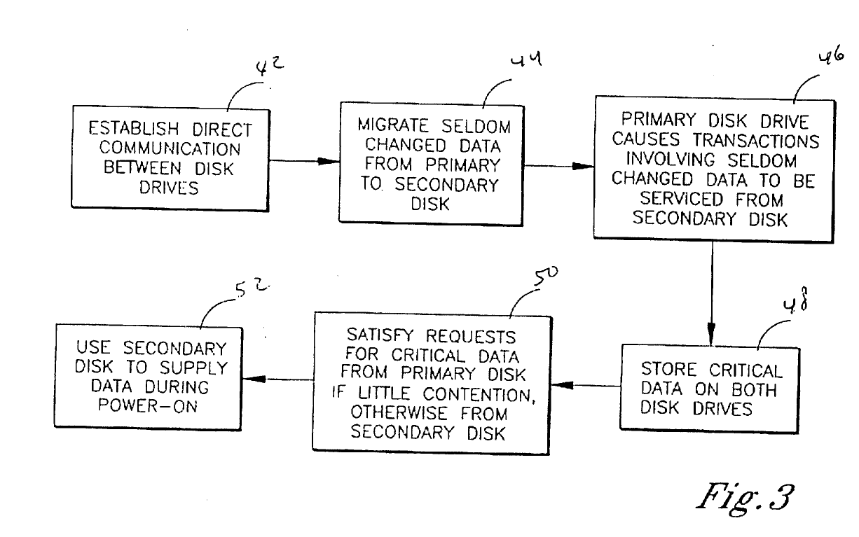

Bearing in mind the above drive-to-drive direct communication without the intervention of the host computer 12, reference is made to FIG. 3, which commences at block 42 with the establishment of the above-disclosed inventive drive-to-drive direct communication.

Some data such as portions of an operating system may seldom if ever change over the life of a disk drive. Other data may change frequently, e.g., Web pages or the current timestamp. Precisely what data is frequently changed and what data is seldom changed can vary with the particular application of the SHDD 13, so as used herein, the term “seldom changed data” is relative to other data used in the particular application. In any case, in some applications some of the seldom-changed data as indicated beforehand or by using the above-mentioned statistics maintained by the control function can be stored on a slower but larger capacity disk drive and more frequently changed data on a lower capacity but faster disk drive in the SHDD 13. Initially, all data might be stored on the high speed but low capacity disk drive and then, as it fills up, seldom-changed data (e.g., data that has been read and left unchanged more than a threshold number of times) moved to a larger capacity but slower disk drive in the SHDD 13.

On the other hand, if the preponderance of the data is changed often, most of the data might be stored on a large high performance disk drive and a smaller low performance disk drive used to stage data onto the system bus 18 as required. In any case, the design of the SHDD can be arranged to match the requirements of the application.

With this in mind, the logic moves to block 44, wherein seldom-changed data is migrated (by copying or moving) to the secondary disk drive 16. The seldom-changed data can then be quickly retrieved at block 46 from the secondary disk drive 16 because there is significantly less contention on the secondary disk drive than on the primary disk drive. Because the disk drives 14, 16 communicate directly with each other, the decision to store static data can be made by the associated disk drive controller (either the primary disk drive controller 20 or secondary disk drive controller 22), and not by the host computer 12.

In some cases, when the secondary disk drive 16 can predict when a particular data set will be required by the host computer 12, it can independently retrieve and store the information in a local buffer so it is ready when requested by the host computer 12. For instance, as disclosed above the SHDD control function can maintain records of how many times files have been read within a window around some time. Accordingly, if, say, a particular file has been read many times at or around 8 A.M. each morning, and other files have not been read as frequently, the particular file may be staged to the appropriate buffer 36, 38, 40 just before 8 A.M. each day for quick response to the expected 8 A.M. read request.

In some applications, only the data on the primary disk drive 14 is considered be the master record. Consequently, in this application, appropriate data files are migrated to the secondary disk drive 16 and then transmitted to the system bus 18 as required. If new data files or updated data files are received from the system bus 18, only the primary disk drive 14 need be updated. Once this is complete, the obsolete copy stored on the secondary disk drive 16 can be deleted. The new version of the data file is then read from the primary disk drive 14 until a refreshed copy is available on the secondary disk drive 16.

In another application, improved performance may necessitate writing data from the bus 18 to the secondary disk drive 16 while the primary disk drive 14 is performing other functions such as retrieving another data file. Once the data is recorded on the secondary disk drive 16, the copy on the primary disk drive 14 is obsolete. It is either deleted from the primary disk drive 14, or marked obsolete, until the data file is updated from the secondary disk drive 16. In this application, the master record for each data file can reside on either disk drive 14, 16 until all the copies are migrated to the primary disk drive 14.

Furthermore, the present invention recognizes that some data stored on the disk drives 14, 16 may be “critical data” as determined by the disk drives 14, 16 themselves or by the host computer 12. At block 48, such critical data is stored on both disk drives 14, 16. When a request is received at block 50 for critical data, it is supplied by the primary disk drive 14 if there is little contention on the primary disk drive 14, and otherwise the critical data is supplied by the secondary disk drive 16.

Even though in some embodiments the secondary disk drive 16 may not have the performance of the primary disk drive 14, it can generally store a significant amount of data (in some embodiments maybe 10% of the capacity of the primary disk drive). Accordingly, much of the critical data, if not all, can be off-loaded to the secondary disk drive 16 if various ongoing tests indicate that the primary disk drive 14 is approaching a failure. Even if the primary disk drive 14 fails, a significant portion of the data is still available on the secondary disk drive 16.

If desired, the logic at block 52 can also be executed. As indicated in FIG. 3, the secondary disk drive 16 can be used to supply critical data during a power-on situation. Because the high-performance primary disk drive 14 usually requires more time to start because of the multiple checks it performs during power-up, the initial data can be supplied more quickly by the secondary disk drive 16. For example, during a power-on sequence, the secondary disk drive 16 can supply at least portions of the operating system to the host computer 12 well before the primary disk drive 14 is ready to supply information.

While the particular SYNERGISTIC HYBRID DISK DRIVE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. '112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A computer system, comprising:
at least a primary disk drive connectable to a system bus and having a primary disk drive controller; and
at least a secondary disk drive connectable to the system bus and having a secondary disk drive controller, the disk drive controllers having the capability of communicating directly with each other without requiring a host computer processor to facilitate communication between the disk drives.

2. The system of claim 1, wherein the primary disk drive is a high performance disk drive.

3. The system of claim 2, wherein the secondary disk drive is mounted on an electronic card packaged with the high performance disk drive.

4. The system of claim 1, wherein the disk drive controllers communicate directly with each other through the system bus.

5. The system of claim 1, wherein the disk drive controllers communicate directly with each other through a control function.

6. The system of claim 1, wherein seldom-changed data is stored on the secondary disk drive, the secondary disk drive satisfying requests from a host computer for the seldom-changed data.

7. The system of claim 1, wherein critical data is stored on both the secondary disk drive and primary disk drive, the primary disk drive satisfying requests for the critical data under conditions of low contention on the primary disk drive, the secondary disk drive satisfying requests for the critical data otherwise.

8. The system of claim 1, wherein the secondary disk drive stores at least portions of an operating system required by a host computer during power-up, at least the portions of the operating system being supplied to the host computer from the secondary disk drive during power-up.

9. The system of claim 1, comprising a host computer communicating with the disk drives over a system bus.

10. A storage system, comprising:
at least a primary storage device having a primary controller; and
at least a secondary storage device having an associated controller communicating directly with the primary controller for satisfying data requests from a host computer communicating with both storage devices over a bus, at least one of the controllers executing logic for undertaking at least activity from the group of activities consisting of:
causing the secondary storage device to satisfy request from a host computer for seldom-changed data;
causing the primary storage device to satisfy requests for critical data under conditions of low contention on the primary storage device and otherwise causing the secondary storage device to satisfy requests for critical data;
causing at least portions of an operating system to be supplied by the secondary storage device to a host computer during power-up.

11. The system of claim 10, wherein at least one storage device is selected from the group of devices consisting of hard magnetic disk drives, floppy drives, optical drives, tape drives, and electronic storage.

12. The system of claim 10, wherein the primary storage device is a primary disk drive and the secondary storage device is a secondary disk drive.

13. The system of claim 12, wherein the primary disk drive is a high performance disk drive.

14. The system of claim 13, wherein the secondary disk drive is mounted on an electronic card packaged with the high performance disk drive.

15. The system of claim 12, wherein the controllers communicate directly with each other through the system bus.

16. The system of claim 12, wherein the controllers communicate directly with each other through a control function.

17. The system of claim 12, comprising a host computer communicating with the disk drives over a system bus.

18. A method for satisfying requests for data from a host computer, comprising:
establishing direct communication between at least a primary disk drive and a secondary disk drive; and
depending on the content of a request for data, using a controller other than the host computer to determine which disk drive will satisfy the request.

19. The method of claim 18, wherein the primary disk drive is a high performance disk drive.

20. The method of claim 19, wherein the secondary disk drive is mounted on an electronic card packaged with the high performance disk drive.

21. The method of claim 18, wherein respective disk drive controllers of the disk drives communicate directly with each other through the system bus.

22. The method of claim 18, wherein respective disk drive controllers of the disk drives communicate directly with each other through a control function.

23. The method of claim 18, comprising storing seldom-changed data on the secondary disk drive and satisfying request from a host computer for the seldom-changed data using the secondary disk drive.

24. The method of claim 18, comprising:
storing critical data on both the secondary disk drive and primary disk drive;
satisfying requests for the critical data using the primary disk drive under conditions of low contention on the primary disk drive; otherwise
satisfying requests for the critical data using the secondary disk drive.

25. The method of claim 18, comprising providing at least portions of an operating system required by a host computer during power-up from the secondary disk drive.
